(19) United States
(12) Patent Application Publication
(10) Pub. No.: US 2017/0262720 A1
(43) Pub. Date: Sep. 14, 2017

(54) FINGERPRINT SENSOR

(71) Applicant: Samsung Electronics Co., Ltd., Suwon-si (KR)

(72) Inventors: Sang Hoon HWANG, Suwon-si (KR); Tah Joon PARK, Suwon-si (KR)

(21) Appl. No.: 15/334,941

(22) Filed: Oct. 26, 2016

(30) Foreign Application Priority Data
Mar. 8, 2016 (KR) 10-2016-0027805
Jun. 7, 2016 (KR) 10-2016-0070515

(51) Int. Cl. G06K 9/00

(52) U.S. Cl. CPC G06K 9/00906; G06K 9/0002; G06K 9/00087

(57) ABSTRACT

A fingerprint sensor includes: a panel including a sensor array including first electrodes extended in a first direction and second electrodes extended in a second direction intersecting with the first direction; and a forged fingerprint analyzer configured to provide signals having different frequencies to a first electrode group and a second electrode group, and to measure an impedance between the first electrode group and the second electrode group to determine whether a fingerprint applied to the sensor array is forged, wherein the first electrode group includes a portion of a plurality of electrodes among the first electrodes or the second electrodes, and the second electrode group includes another portion of the plurality of electrodes.

### CROSS-REFERENCE TO RELATED APPLICATIONS

This application claims benefit under 35 USC 119(a) of Korean Patent Application Nos. 10-2016-0027805 and 10-2016-0070515 filed on Mar. 8, 2016 and Jun. 7, 2016, respectively, in the Korean Intellectual Property Office, the entire disclosures of which are incorporated herein by reference for all purposes.

### BACKGROUND

1. Field

The following description relates to a fingerprint sensor.

2. Description of Related Art

As various services such as FinTech, which uses software to provide financial services, are provided through mobile apparatuses, the need to protect personal information stored on mobile apparatuses has increased. Accordingly, a fingerprint sensor, which is configured to sense a fingerprint of a finger to authenticate a user, has been used in order to enhance the security of mobile apparatuses.

A fingerprint sensor may be an ultrasonic-type fingerprint sensor, an infrared-type fingerprint sensor, a capacitive fingerprint sensor, or another type of fingerprint sensor. A capacitive fingerprint sensor senses changes in capacitance to detect valleys and peaks of the fingerprint.

The fingerprint sensor may be able to precisely detect a fingerprint of an unauthenticated user and a fingerprint of an authenticated user. However, the fingerprint sensor may not be able to clearly detect a forged fingerprint that is forged, for example, using a material such as silicon or gelatin, based on the fingerprint of an authenticated user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fingerprint sensor includes: a panel including a sensor array including first electrodes extended in a first direction and second electrodes extended in a second direction intersecting with the first direction; and a forged fingerprint analyzer configured to provide signals having different frequencies to a first electrode group and a second electrode group, and to measure an impedance between the first electrode group and the second electrode group to determine whether a fingerprint applied to the sensor array is forged, wherein the first electrode group includes a portion of a plurality of electrodes among the first electrodes or the second electrodes, and the second electrode group includes another portion of the plurality of electrodes.

The first electrode group and the second electrode group may be spaced apart from each other with an electrode among the plurality of electrodes disposed between the first electrode group and the second electrode group. The electrode among the plurality of electrodes may be floated.

Some electrodes included in the first electrode group and the second electrode group may be continuously disposed adjacent to each other.

The forged fingerprint analyzer may include a frequency signal provider configured to provide a high frequency signal, a low frequency signal, and a reference signal to the first electrode group and the second electrode group.

The frequency signal provider may be configured to provide the high frequency signal to the first electrode group, and to provide the reference signal to the second electrode group, at a first point in time. The frequency signal provider may be configured to provide the low frequency signal to the first electrode group, and to provide the reference signal to the second electrode group, at a next point in time after the first point in time.

The forged fingerprint analyzer may further include an impedance measurer configured to measure the impedance between the first electrode group and the second electrode group at the first point in time and the next point in time.

The forged fingerprint analyzer may further include a forged fingerprint determiner configured to determine whether the fingerprint is forged by comparing the impedance measured at the first point in time and the impedance measured at the next point in time with each other.

The forged fingerprint analyzer may be configured to determine that the fingerprint is forged, in response to a difference between the impedance measured at the first point in time and the impedance measured at the next point in time being slight.

The fingerprint sensor may further include a fingerprint sensing circuit module configured to: apply driving signals to the first electrodes; and detect, from the second electrodes, capacitances generated between the first electrodes and the second electrodes to sense the fingerprint.

In another general aspect, a fingerprint sensor includes: a panel including a sensor array including first electrodes and second electrodes disposed above the first electrodes, and an auxiliary electrode unit including auxiliary electrodes disposed adjacent to the sensor array; a fingerprint sensing circuit module configured to sense a fingerprint from capacitances generated between the first electrodes and the second electrodes; and a forged fingerprint analyzer configured to provide signals having different frequencies to the auxiliary electrodes, and to determine whether the fingerprint is forged based on an impedance between the auxiliary electrodes.

The forged fingerprint analyzer may be configured to provide a high frequency signal to one or more electrodes among the auxiliary electrodes. The fingerprint sensing circuit module may be configured to determine whether the fingerprint is forged based on capacitances formed between the second electrodes and one or more electrodes among the auxiliary electrodes.

The fingerprint sensing circuit module may be further configured to determine that the fingerprint is forged, in response to an increase in the capacitances formed between the second electrodes and the one or more electrodes among the auxiliary electrodes.

The fingerprint sensing circuit module may be further configured to detect whether the fingerprint is forged based on whether a distance is present between an edge region of the sensor array and a contact object disposed on the sensor array.

The panel may further include a conductive layer formed on the auxiliary electrodes.

The sensor array may be disposed in a central region of a home button configured to provide a physical input to an electronic apparatus. The auxiliary electrodes may be formed by a metal ring including two parts formed on an outer side of the home button.

The sensor array may be disposed in a central region of a home button configured to provide a physical input to an electronic apparatus. The auxiliary electrodes may be disposed in outer regions of the home button surrounding the central region of the home button.

The panel may be formed in one or both of a display region and a bezel region of an electronic apparatus.

Each of the auxiliary electrodes may be spaced apart from the sensor array by a distance of 3 μm or less.

In another general aspect, a fingerprint sensing apparatus includes: a frequency signal provider configured to provide signals having different frequencies to a sensor array including first electrodes extended in a first direction and second electrodes extended in a second direction; an impedance measurer configured to measure an impedance between a first electrode group and a second electrode group, wherein the first electrode group and the second electrode group each include electrodes among the first electrodes, or each include electrodes among the second electrodes; a fingerprint forgery determiner configured to determine whether a fingerprint applied to the sensor array is forged based on the measured impedance; and a sensing circuit module configured to apply driving signals to the first electrodes, and detect, from the second electrodes, capacitances generated between the first electrodes and the second electrodes to sense the fingerprint.

The providing of the signals having different frequencies to the sensor array may include: providing a first signal having a first frequency to the first electrode group, and providing a reference signal to the second electrode group, at a first point in time; and providing a second signal having a second frequency to the first electrode group, and providing the reference signal to the second electrode group, at a next point in time after the first point in time. The measuring of the impedance between the first electrode group and the second electrode group may include measuring the impendence between the first electrode group and the second electrode group at the first point in time and the next point in time.

The fingerprint forgery determiner may be configured to determine that the fingerprint is forged, in response to a difference between the impedance measured at the first point in time and the impedance measured at the next point in time being slight.

The first electrode group and the second electrode group may be spaced apart from each other by a floated electrode.

In another general aspect, an electronic apparatus includes: a button configured to provide a physical input to the electronic apparatus, wherein the button includes a sensor array disposed in a central region of the button, and including first electrodes and second electrodes, and auxiliary electrodes disposed in the button in one or both of an outer region of the button surrounding the sensor array and a metal ring formed at an outer circumference of the button; a fingerprint sensing circuit module configured to sense a fingerprint from capacitances generated between the first electrodes and the second electrodes by a contact object disposed on the sensor array; and a forged fingerprint analyzer configured to determine whether the fingerprint is forged based on capacitances formed between the second electrodes and an electrode among the auxiliary electrodes.

Each of the auxiliary electrodes may be spaced apart from the sensor array by a distance less than 3 μm.

The forged fingerprint analyzer may be further configured to: provide signals having different frequencies to the auxiliary electrodes; and determine whether the fingerprint is forged based on an impedance between the auxiliary electrodes.

The fingerprint sensing circuit module may be further configured to detect whether the fingerprint is forged based on whether a distance is present between an edge region of the sensor array and the contact object.

Other features and aspects will be apparent from the following detailed description, the drawings, and the claims.

### BRIEF DESCRIPTION OF DRAWINGS

FIG. 1 is a view of an electronic apparatus including a fingerprint sensor, according to an embodiment.

FIG. 2 is a block diagram of a fingerprint sensor, according to an embodiment.

FIGS. 3A and 3B are top views illustrating a sensor array included in a panel, according to an embodiment.

FIG. 4 is a cross-sectional view of a sensor array included in a panel, according to an embodiment.

FIGS. 5 and 6 are views illustrating examples of schemes of grouping electrodes in a sensor array.

FIGS. 7A and 7B are views illustrating examples of paths of a high frequency signal provided to a living body part and paths of a low frequency signal, respectively, provided to a living body part.

FIG. 8A is a graph illustrating a magnitude of impedance depending on a change in a frequency, according to an embodiment. FIG. 8B is a graph illustrating a phase of impedance depending on a change in a frequency, according to an embodiment.

FIG. 9 is a block diagram of a fingerprint sensor, according to another embodiment.

FIG. 10 is a cross-sectional view of a panel, according to an embodiment.

FIGS. 11A through 12E are views illustrating examples of layouts and implementations of a panel.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

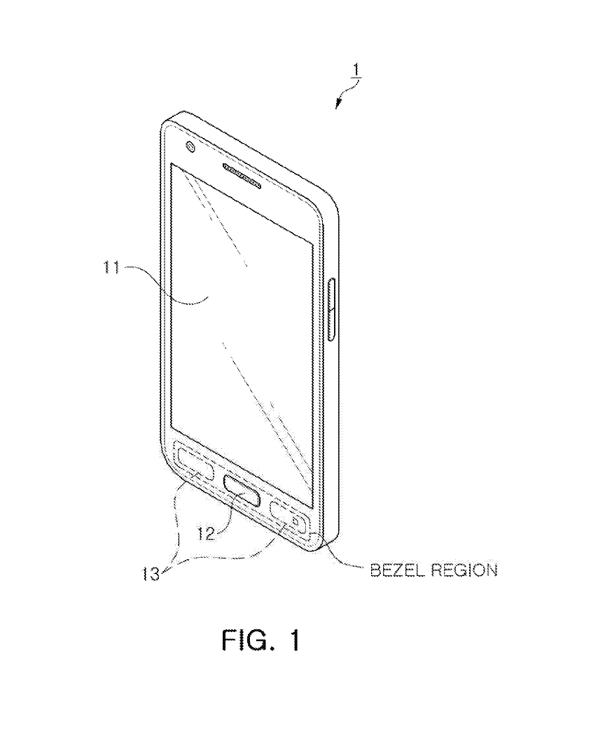

FIG. 1 is a view of an electronic apparatus 1 including a fingerprint sensor, according to an embodiment. Referring to FIG. 1, the electronic apparatus 1 includes a display 11, a first auxiliary input 12, and a second auxiliary input 13.

The display 11 includes a structural output device such as a liquid crystal display device (LCD), an organic light emitting diode (OLED), or another type of output device configured to output an image, and includes a transparent touch panel on the output device that is configured to recognize a main touch input of a user.

The first auxiliary input 12 and the second auxiliary input 13 are configured to recognize inputs of the user other than the main touch input to the touch panel. The first auxiliary input 12 and the second auxiliary input 13 may be formed in a bezel region of the electronic apparatus 1 to allow wirings of the display 11 to be hidden from view through transparent portions of the display 11. The first auxiliary input unit 12 may include a home button configured to receive a physical input of the user, and the second auxiliary input unit 13 may include a touch key configured to perform a set control of the electronic apparatus to recognize auxiliary touch input.

According to an embodiment, the fingerprint sensor is formed below at least one of a region in which the display 11 is provided and the bezel region in which the first auxiliary input 12 and the second auxiliary input 13 are provided, and is configured to determine release of a sleep mode of the electronic apparatus 1 and turning-on or turning-off of a power supply of the electronic apparatus 1.

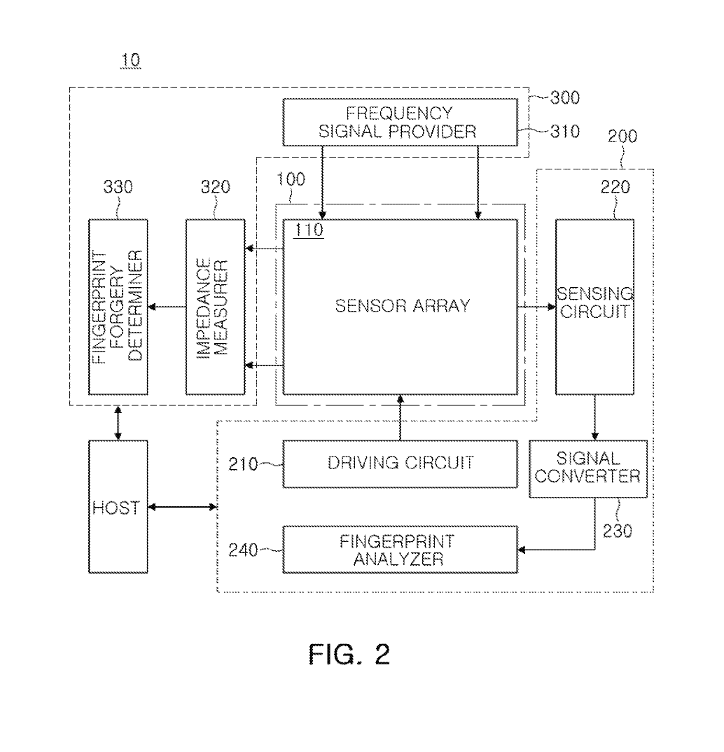

FIG. 2 is a block diagram illustrating a fingerprint sensor 10, according to an embodiment. Referring to FIG. 2, a fingerprint sensor 10 includes a touch panel, or “panel” 100, a fingerprint sensing circuit module 200, a forged fingerprint analyzer 300, and a host 400.

The panel 100 includes a sensor array 110 including a substrate and electrodes provided on the substrate. The electrodes of the sensor array 110 are used to perform a fingerprint sensing operation of the fingerprint sensing circuit module 200 and a forged fingerprint determining operation of the forged fingerprint analyzer 300.

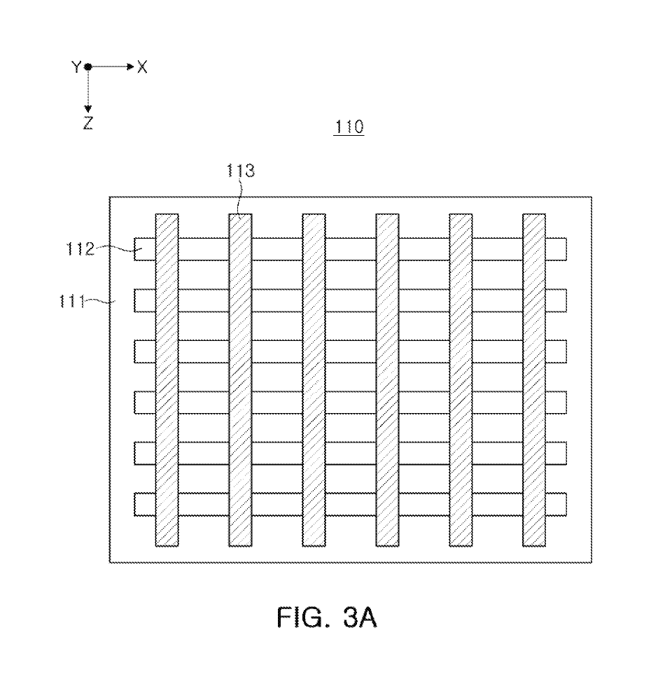

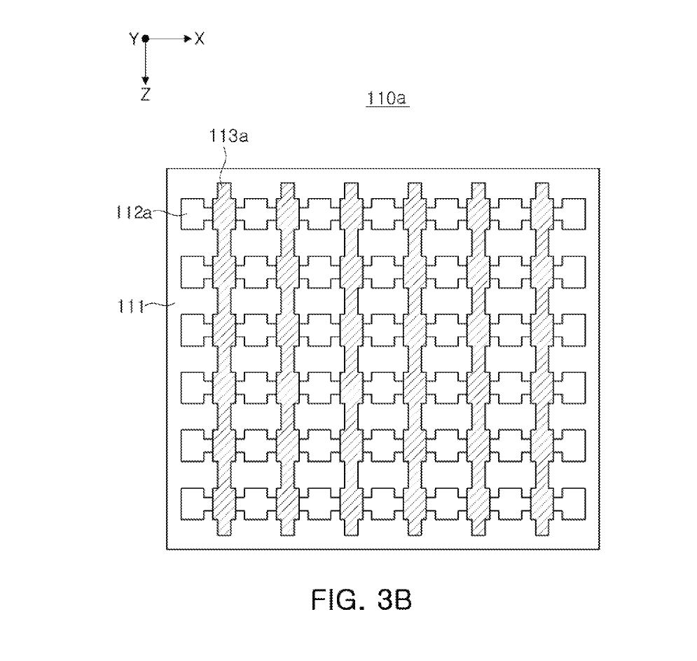

FIG. 3A is a top view of a sensor array 110 included in the panel 100, according to an embodiment. FIG. 3B shows a sensor array 110a, according to another embodiment, which is a variation of the sensor array 110. FIG. 4 is a cross-sectional view of the sensor array 110 taken along the Y-Z plane of FIG. 3A. It can be appreciated that a cross-sectional view of the sensor array 110a taken along the Y-Z plane of FIG. 3B may have an appearance that is similar to that of the view shown in FIG. 4.

Referring to FIG. 3A, the sensor array 110 includes a substrate 111, first electrodes 112, and second electrodes 113. Referring to FIG. 4, the sensor array 110 further includes a cover lens 114 configured to be contacted by a body part of a user, such as a finger, or by an object manipulated by a user.

Referring to FIGS. 3A and 4, the substrate 111 may be formed of a film such as a polyethylene terephthalate (PET) film, a polycarbonate (PC) film, a polyethersulf one (PES) film, a polyimide (PI) film, a polymethlymethacrylate (PMMA) film, a cyclo-olefin polymer (COP) film, or the like, a soda glass, or a tempered glass to have high light transmissivity.

Referring to FIG. 3A, the first electrodes 112 extend lengthwise in a first direction (an X-axis direction), and the second electrodes 113 extend lengthwise in a second direction (a Y-axis direction) intersecting with the first direction. The first electrodes 112 and the second electrodes 113 may be formed on a same surface or different surfaces of the substrate 111, and in a case in which both of the plurality of first electrodes 112 and the plurality of second electrodes 113 are formed on the same surface of the substrate 111, an insulating layer may be formed between the first electrodes 112 and the second electrodes 113. The first electrodes 112 and the second electrodes 113 may have shapes in which they are extended while having constant widths in the X-Y plane.

Referring to FIG. 3B, the sensor array 110a is similar to the sensor array 110, except that the sensor array 110a includes first electrodes 112a and second electrodes 113a having different configurations than the first electrodes 112 and second electrodes 113, respectively, of the sensor array 110. For example, the first electrodes 112a and the second electrodes 113a each include a pattern formed by repeated portions having a quadrangular shape, in order to improve sensitivity. Alternatively, the first electrodes 112a and the second electrodes 113a may each include a pattern formed by repeated portions having a shape such as a rhomboidal shape, a diamond shape, a circular shape, a triangular shape, or another geometric shape.

Although particular numbers and configurations of first electrodes 112/112a and second electrodes 113/113a are illustrated for convenience of explanation in FIGS. 3A through 4, the numbers and configurations of the electrodes 112/112a and 113/113a may be changed.

Referring to FIG. 2, the fingerprint sensing circuit module 200 includes a driving circuit 210, a sensing circuit 220, a signal converter 230, and a fingerprint analyzer 240. The driving circuit 210, the sensing circuit 220, the signal converter 230, and the fingerprint analyzer 240 may be implemented by a single integrated circuit (IC).

The fingerprint sensing circuit module 200 applies driving signals to the plurality of first electrodes 112/112a of FIG. 3A/3B, and senses a fingerprint by detecting capacitances generated at nodes, which are locations at which the first electrodes 112 and the second electrodes 113 intersect each other, from the second electrodes 113a/113b.

The driving circuit 210 applies driving signals to the first electrodes 112/112a. The driving signal may be a square wave signal, a sine wave signal, a triangle wave signal, or other signal, having a predetermined period and amplitude. The driving circuit 210 may be individually connected to each of the first electrodes 112/112a to apply the driving signals to the first electrodes 112/112a, or the driving circuit 210 may be connected to the first electrodes 112/112a through a switching circuit such that the driving circuit 210 is configured to selectively apply the driving signals to each one or groups of the first electrodes 112/112a using the switching circuit. In an example, the driving circuit 210 sequentially applies the driving signals to the first electrodes 112/112a or groups of the first electrodes 112/112a.

The sensing circuit 220 detects the capacitances from the second electrodes 113/113a. When the driving signals are applied to the first electrodes 112/112a by the driving circuit 210, the capacitances are generated at the nodes, and changes in the capacitances are generated depending on a distance difference between valleys and peaks of a fingerprint of a finger approaching the sensor array 110.

The sensing circuit 220 may include C-V converting circuits, each of which includes at least one operational amplifier and at least one capacitor configured to convert the capacitances generated at the nodes into analog voltage signals. The C-V converting circuits may be connected to each of the second electrodes 113/113a, respectively. In an example, the C-V converting circuits integrate the capacitances to convert the capacitances into voltage signals and output the voltage signals. The C-V converting circuits may integrate the capacitances using a predetermined integration function.

In an example, the sensing circuit 220 simultaneously detects the capacitances from the second electrodes 113/113a, and the number of C-V converting circuits included in the sensing circuit 220 corresponds to the number of second electrodes 113/113a in order to enable simultaneous detection of the capacitances.

The signal converter 230 converts the voltage signals output from the sensing circuit 220 into digital signals, and transfers the digital signals to the fingerprint analyzer 240.

In an example, the signal converter 230 includes a time-to-digital converter (TDC) circuit that measures times in which the voltage signals output from the sensing circuit 220 arrive at a predetermined reference voltage level and converts the measured time into digital signals, or an analog-to-digital converter (ADC) circuit that measures amounts by which levels of the voltage signals output from the sensing circuit 220 are changed for a predetermined time and converts the change amounts into digital signals.

The fingerprint analyzer 240 generates fingerprint information including an image form from the digital signals, which are transferred from the signal converter 230. The fingerprint analyzer 240 compares the generated fingerprint information with previously stored fingerprint information to authenticate a user.

Referring to FIG. 2, the forged fingerprint analyzer 300 includes a frequency signal provider 310, an impedance measurer 320, and a fingerprint forgery determiner 330. In an example, the forged fingerprint analyzer 300 measures impedance and determines whether or not a fingerprint is forged using a magnitude and a phase of the measured impedance.

Referring to FIGS. 2 through 3B, in an example, the frequency signal provider 310 provides frequency signals to an impedance measuring electrode unit corresponding to some of the electrodes 112/112a or 113/113a extended in any one direction, the impedance measurer 320 measures impedance from the impedance measuring electrode unit, and the fingerprint forgery determiner 330 determines whether or not the fingerprint is forged based on the measured impedance.

The impedance measuring electrode unit includes one or more electrode groups. The electrode groups may include some of the electrodes 112/112a or 113/113a extended in any one direction.

In an example, the electrode groups include a first electrode group and a second electrode group. At least one of the first electrodes 112/112a may be included in the first electrode group, and at least one of the first electrodes 112/112a that is not included in the first electrode group may be included in the second electrode group. Alternatively, at least one of the second electrodes 113/113a may be included in the first electrode group, and at least one of the second electrodes 113/113a that is not included in the first electrode group may be included in the second electrode group.

The first electrode group and the second electrode group may be spaced apart from each other with at least one electrode interposed therebetween in the first electrodes 112/112a or the second electrodes 113/113a. In addition, the first electrode group and the second electrode group may be spaced apart from each other by the greatest possible distance (e.g., with the greatest possible number of electrodes therebetween) in the plurality of first electrodes 112/112a or the plurality of second electrodes 113/113a.

In a case in which each of the first electrode group and the second electrode group includes a single electrode from among the first electrodes 112/112a and the number of the first electrodes 112/112a is X (where X indicates a natural number of 3 or more), a first electrode disposed in a Y-th position (where 1≦Y<X and Y indicates a natural number) may correspond to the first electrode group, and a first electrode disposed at a Z-th position (where Y<Z≦X and Z indicates a natural number) may correspond to the second electrode group.

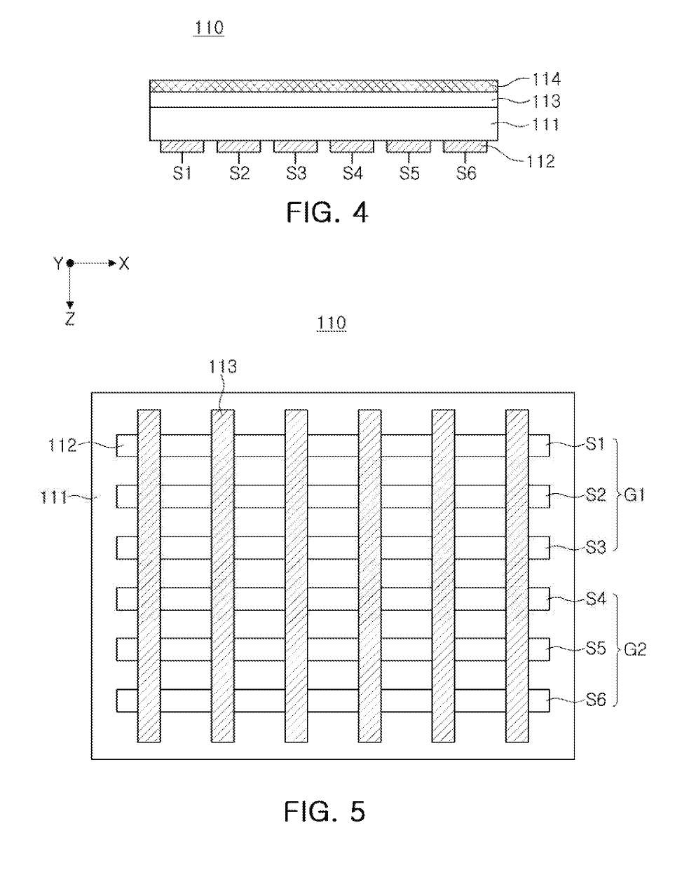

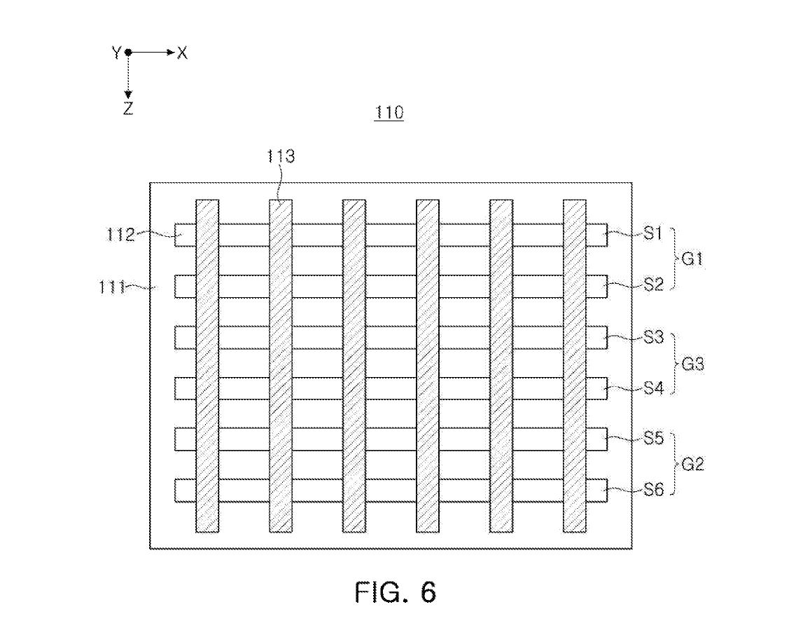

An example in which each of the first electrode group and the second electrode group includes a plurality of electrodes will be described with reference to FIGS. 5 and 6. While FIGS. 5 and 6 and the associated description are directed to an embodiment including the first electrodes 112 and the second electrodes 113, it is to be understood that the description related to FIGS. 5 and 6 also applies to an embodiment including the first electrodes 112a and the second electrodes 113a shown in FIG. 3B.

FIGS. 5 and 6 are views illustrating examples of schemes of grouping electrodes in a sensor array, according to an embodiment. In the example of FIG. 5, electrodes S1 to S3 continuously disposed adjacent to each other among the first electrodes 112 of the sensor array 110 correspond to a first electrode group G1, and electrodes S4 to S6 continuously disposed adjacent to each other among the first electrodes 112 correspond to a second electrode group G2. In the example of FIG. 6, electrodes S1 and S2 continuously disposed adjacent to each other among the first electrodes 112 of the sensor array 110 are grouped into a first electrode group G1, and electrodes S5 and S6 continuously disposed adjacent to each other among the first electrodes 112 of the sensor array 110 are grouped into a second electrode group G2. In addition, electrodes S3 and S4 continuously disposed adjacent to each other among the first electrodes 112 of the sensor array 110 are grouped into a third electrode group G3.

As described below, the frequency signal provider 310 provides high and/or low frequency signals to the first electrode group G1 among the electrode groups and provides a reference signal to the second electrode group G2 among the electrode groups. In this case, the third electrode group G3 is floated to thereby be used as a depletion region to reduce noise that may be generated between the first electrode group G1 and the second electrode group G2.

Although an example in which the first electrodes 112 are grouped into the first to third electrode groups G1 to G3 is illustrated in FIGS. 5 and 6, in another example, the second electrodes 113 may be grouped into groups to set the first to third electrode groups G1 to G3.

Again referring to FIG. 2, the frequency signal provider 310 provides the frequency signals to the first electrode group G1 and the second electrode group G2. The frequency signals may include the high and/or low frequency signals and the reference signal. For example, the reference signal corresponds to a ground voltage. The frequency signal provider 310 may include a constant current source to provide a high frequency signal and a low frequency signal having a sinusoidal wave current form.

In an example, the frequency signal provider 310 provides the high and/or low frequency signals to the first electrode group G1 and provides the reference signal to the second electrode group G2. More specifically, at a first point in time, the frequency signal provider 310 may provide the high frequency signal to the first electrode group G1 and may provide the reference signal to the second electrode group G2. In addition, at a next point in time after the first point in time, the frequency signal provider 310 may provide the low frequency signal to the first electrode group G1 and may provide the reference signal to the second electrode group G2.

The impedance measurer 320 measures impedance between the first electrode group G1 and the second electrode group G2. More specifically, the impedance measurer 320 may sample signals output from the first electrode group G1 and the second electrode group G2 as two signals using phase signals that are orthogonal to each other, and may measure a magnitude and a phase of the impedance from the two sampled signals. The impedance measurer 320 may measure a magnitude and a phase of impedance between the first electrode group G1 and the second electrode group G2 at the first point in time, and may measure a magnitude and a phase of impedance between the first electrode group G1 and the second electrode group G2 at the next point in time after the first point in time.

The fingerprint forgery determiner 330 determines whether or not the fingerprint is forged based on the impedance transferred from the impedance measurer 320. More specifically, the fingerprint forgery determiner 330 determines whether or not the fingerprint is forged by comparing the magnitude and the phase of the impedance measured at the first point in time and the magnitude and the phase of the impedance measured at the next point in time with each other. For example, the forged fingerprint analyzer 300 determines that the fingerprint is forged in response to a difference between the impedance measured at the first point in time and the impedance measured at the second point in time being slight. More specifically, the forged fingerprint analyzer 300 may determine that the fingerprint is forged in response to a difference between the magnitude of the impedance measured at the first point in time and the magnitude of the impedance measured at the second point in time being below a threshold magnitude difference, and/or a difference between the phase of the impedance measured at the first point in time and the phase of the impedance measured at the second point in time being below a threshold phase difference.

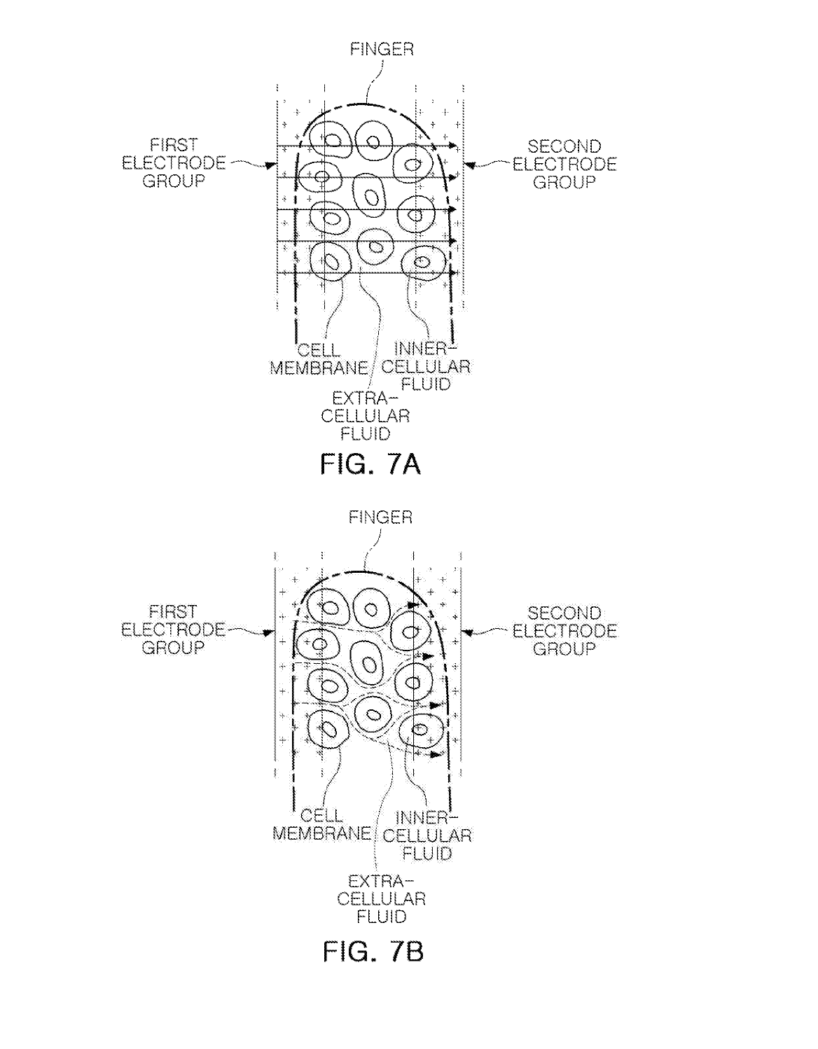

FIG. 7A is a view illustrating paths of a high frequency signal provided to a living body part. FIG. 7B is a view illustrating paths of a low frequency signal provided to a living body part.

Referring to FIG. 7A, when a living body part such as a finger is disposed on the first electrode group G1 and the second electrode group G2, in an example in which the high frequency signal and the reference signal are provided from the frequency signal provider 310 to the first electrode group G1 and the second electrode group G2, respectively, the high frequency signal may pass through a cell membrane of the finger, such that a path of the high frequency signal passing may be formed through an extra-cellular fluid, an inner-cellular fluid, and the cell membrane, as illustrated by the arrows.

In addition, referring to FIG. 7B, when a living body part such as a finger is disposed on the first electrode group G1 and the second electrode group G2, in a case in which the low frequency signal and the reference signal are provided from the frequency signal provider 310 to the first electrode group G1 and the second electrode group G2, respectively, the low frequency signal does not pass through a cell membrane of the finger, such that a path of the low frequency signal may be formed in an extra-cellular fluid of the finger, as illustrated by the arrows arrow.

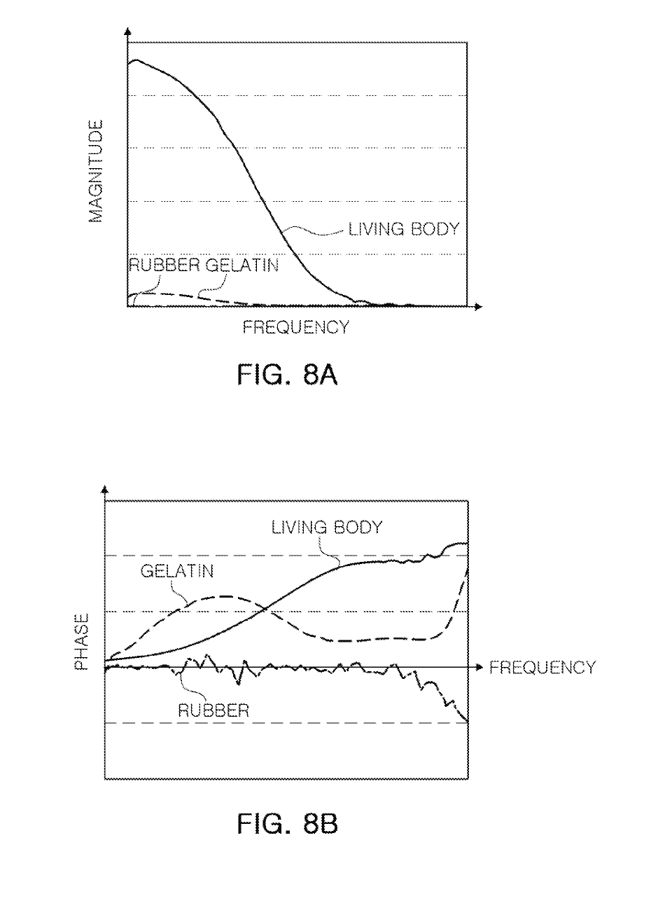

FIG. 8A is a graph illustrating a magnitude of impedance depending on a change in a frequency, according to an embodiment. FIG. 8B is a graph illustrating a phase of impedance depending on a change in a frequency, according to an embodiment.

Referring to FIGS. 8A and 8B, it can be confirmed that, when a living body part is disposed on electrode groups (e.g., electrode groups G1 and G2), the paths of the high frequency signal and the low frequency signal are different from each other as described above, such that a difference between magnitudes and phases of impedances in a high frequency region and a low frequency region is significantly large. However, when a non-living body such as a gelatin or rubber body is disposed on electrode groups (e.g., electrode groups G1 and G2), differences between magnitudes and phases of impedances in a low frequency region and magnitudes and phases of impedances in a high frequency region are slight. Therefore, the forged fingerprint analyzer 300 determines whether or not the fingerprint is forged based on changes in the magnitude and the phase of the impedance.

Again referring to FIG. 2, the host 400 may be an application processor (AP) or a central processing unit (CPU) of the electronic apparatus 1 in which the fingerprint sensor 10 is mounted. The host 400 controls operations of the fingerprint sensing circuit module 200 and the forged fingerprint analyzer 300, and receives a fingerprint sensing result of the fingerprint sensing circuit module 200 and a forged fingerprint determining result of the forged fingerprint analyzer 300 to perform a set operation. More specifically, the host 400 may control the forged fingerprint analyzer 300 to first perform a forged fingerprint determining operation, and may control the fingerprint sensing circuit module 200 to subsequently perform a fingerprint sensing operation.

In response to a determination that a contact object (i.e., an object contacting electrode groups such as electrode groups G1 and G2) is a part of a living body, such as a finger, the host 400 controls the fingerprint sensing circuit module 200 to perform the fingerprint sensing operation, as a decision result of the forged fingerprint analyzer 300. On the contrary, in response to a determination that a contact object is a non-living body, such as gelatin body or a rubber body, as a decision result of the forged fingerprint analyzer 300, the host 400 may output a warning message through a display device, an audio unit, or the like, of the electronic apparatus when the number of times determined that the contact object is the non-living body is less than the limited number of times, and may end the forged fingerprint determining operation and maintain the electronic apparatus in a locking state when the number of times determined that the contact object is the non-living body is equal to or larger than the limited number of times.

In addition, the host 400 may control the fingerprint sensing module 200 to first perform the fingerprint sensing operation, and control the forged fingerprint analyzer 300 to subsequently perform the forged fingerprint determining operation.

The host 400 may control the forged fingerprint analyzer 300 to thereby perform the forged fingerprint determining operation, in a case in which a fingerprint coincides with a fingerprint of an authenticated user as a decision result of the fingerprint sensing module 200. To the contrary, in a case in which it is determined that a fingerprint does not coincide with the fingerprint of the authenticated user as a decision result of the forged fingerprint sensing module 200, the host 400 may output a warning message through one or both of the display device and an audio device of the electronic apparatus 1 when the number of times it is determined that the fingerprint does not coincide with the fingerprint of the authenticated user is less than a threshold number of times, and may end the fingerprint sensing operation and maintain the electronic apparatus 1 in a locking state when the number of times it is determined that the fingerprint does not coincide with the fingerprint of the authenticated user is equal to or larger than the threshold number of times.

Again referring to FIG. 4, an electrode S1 and an electrode S6 among the first electrodes S1 to S6 of the sensor array 110 may correspond to the first electrode group G1 and the second electrode G2 group described above, respectively. The electrode S1 and the electrode S6 need to measure impedance of a finger of a user in order for the forged fingerprint determining operation and the fingerprint sensing operation to be performed. However, the cover lens 114, which is disposed between the electrodes S1 and S6 and the finger, is generally formed of an insulating material and directly contacts the finger of the user, such that the impedance of the finger may not be precisely measured.

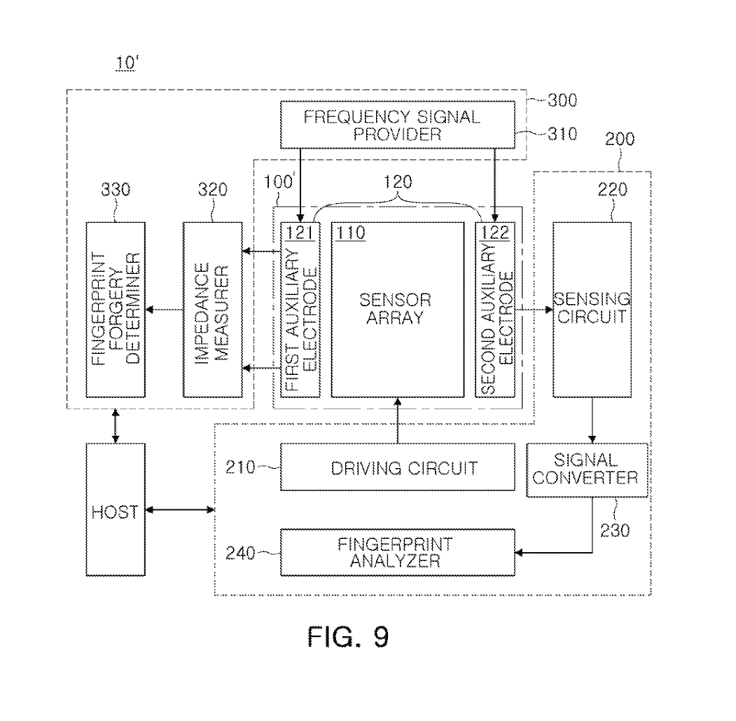

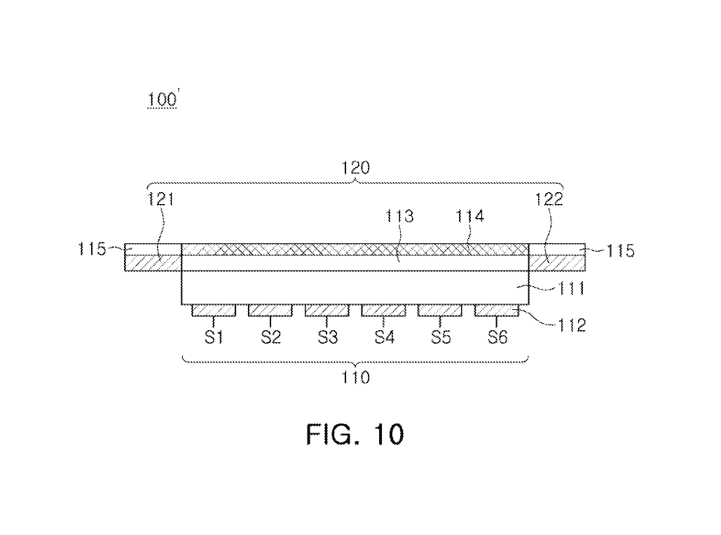

FIG. 9 is a block diagram illustrating a fingerprint sensor 10′, according to another embodiment. FIG. 10 is a cross-sectional view illustrating a panel 100′, according to an embodiment. As shown in FIGS. 9 and 10, the panel 100′ of the fingerprint sensor 10′ includes an auxiliary electrode unit 120 in addition to the sensor array 110, and includes a conductive layer 115 formed on the auxiliary electrode unit 120 to precisely measure impedance.

Referring to FIG. 9, the fingerprint sensor 10′ includes the panel 100′, a fingerprint sensing circuit module 200, a forged fingerprint analyzer 300, and a host 400. The fingerprint sensor 10′ is similar to the fingerprint sensor 10 in the embodiment described above with reference to FIG. 2, but includes additional components. Therefore, a description of contents that are the same as or overlapped with the contents described above will be omitted, and contents different from or in addition to the contents described above will primarily be described.

The auxiliary electrode unit 120 includes at least two auxiliary electrodes 121 and 122. The auxiliary electrodes 121 and 122 are disposed opposite to each other with the sensor array 110 interposed therebetween. Although an example in which the auxiliary electrodes 121 and 122 have a quadrangular shape is illustrated in FIG. 9, the auxiliary electrodes 121 and 122 may have various shapes such as a triangular shape, a rhomboidal shape, or another geometric shape.

In addition, although only two auxiliary electrodes 121 and 122 are illustrated in FIG. 9, more than two auxiliary electrodes may be disposed in the vicinity of the sensor array 110. The two or more auxiliary electrodes may be spaced apart from the sensor array 110 by a predetermined distance. Hereinafter, for convenience of explanation, an example in which the auxiliary electrode unit 120 includes a first auxiliary electrode 121 and a second auxiliary electrode 122 will be described.

The frequency signal provider 310 provides frequency signals to the first auxiliary electrode 121 and the second auxiliary electrode 122 of the auxiliary electrode unit 120. The impedance measurer 320 measures impedances of the first auxiliary electrode 121 and the second auxiliary electrode 122, and the fingerprint forgery determiner 330 determines whether or not a fingerprint is forged based on the measured impedances.

That is, the first electrode group G1 and the second electrode group G2 of the impedance measuring electrode unit in the embodiment described above with reference to FIG. 2 may correspond to the first auxiliary electrode 121 and the second auxiliary electrode 122 of the auxiliary electrode unit 120 in the embodiment of FIG. 9.

Referring to FIG. 10, the panel 100′ further includes a conductive layer 115 formed on the first auxiliary electrode 121 and the second auxiliary electrode 122. According to an embodiment, the conductive layer 115 is formed on the first and second auxiliary electrodes 121 and 122 to precisely measure the impedances.

Referring to FIG. 10, in a case in which a finger of a user is positioned on the sensor array 110 and the first and second auxiliary electrodes 121 and 122, a fingerprint sensing operation is performed through the fingerprint sensing circuit module 200 and a forged fingerprint determining operation is performed through the forged fingerprint analyzer 300.

However, when a forged fingerprint forged using a body formed of gelatin or rubber, for example, is positioned on the sensor array 110 and a finger of an unauthenticated user rather than an authenticated user is positioned on the first auxiliary electrode 121 and the second auxiliary electrode 122, the fingerprint sensor 10′ may erroneously determine that a fingerprint of the unauthenticated user is a fingerprint of the authenticated user.

A size of the forged fingerprint and a length of the sensor array in one direction will be compared with each other and be described. In a case in which the size of the forged fingerprint is longer than the length of the sensor array 110 in one direction, a portion of the forged fingerprint is disposed on the first auxiliary electrode 121 and the second auxiliary electrode 122, and thus, the forged fingerprint analyzer 300 determines whether or not the fingerprint is forged through the first auxiliary electrode 121 and the second auxiliary electrode 122.

In this case, in order to improve accuracy of the decision of the forged fingerprint analyzer 300 on whether or not the fingerprint is forged, the first auxiliary electrode 121 and the second auxiliary electrode 122 may be disposed adjacent to the sensor array 110. As an example, each of the first auxiliary electrode 121 and the second auxiliary electrode 122 may be spaced from the sensor array 110 by a distance equal to or less than 3 μm.

However, to the contrary, in a case in which the size of the forged fingerprint is smaller than the length of the sensor array 110 in one direction, a portion of the forged fingerprint may not be disposed on the first auxiliary electrode 121 and the second auxiliary electrode 122, and thus, the fingerprint sensor 10′ may erroneously determine that the forged fingerprint is the fingerprint of the authenticated user.

According to an embodiment, the fingerprint sensor 10′ performs the following complimentary operations in order to more precisely detect whether or not a fingerprint is forged.

First Complementary Operation

Referring to FIG. 9, the frequency signal provider 310 of the forged fingerprint analyzer 300 provides a high frequency signal to one or both of the first auxiliary electrode 121 and the second auxiliary electrode 122, and the sensing circuit 220 of the fingerprint sensing circuit module 200 converts capacitances formed between the second electrodes 113 and one or both of the first auxiliary electrode 121 and the second auxiliary electrode 122 into voltage signals and then outputs the voltage signals. The signal converter 230 converts the voltage signals into digital signals, and the fingerprint analyzer 240 determines whether or not the fingerprint is forged from the digital signals transferred from the signal converter 230.

When a part of a living body, such as a finger, is disposed on the sensor array 110, the capacitances formed between the second electrodes 113 and one or both of the first auxiliary electrode 121 and the second auxiliary electrode 122 decreases, such that levels of the voltage signals decrease. On the other hand, when a forged fingerprint forged using gelatin or rubber, for example, is disposed on the sensor array 110, the capacitances formed between the second electrodes 113 and one or both of the first auxiliary electrode 121 and the second auxiliary electrode 122 increase, such that level of the voltage signals increases. Therefore, the fingerprint analyzer 240 determines whether or not the fingerprint is forged based on the increase or the decrease in the levels of the voltage signals obtained from the digital signals transferred from the signal converter 230.

Second Complementary Operation

When a contact object such as a forged fingerprint is disposed in the sensor array 110 and a size of the contact object is smaller than the length of the sensor array 110 in one direction, the fingerprint analyzer 240 determines whether or not the fingerprint is forged based on a distance between the contact object and an edge region of the sensor array 110.

When the contact object is not the forged fingerprint, but is a fingerprint of a finger, the distance may not be present between the contact object and the edge region of the sensor array 110. However, in a case in which the contact object is the forged fingerprint, the distance may be present between the contact object and the edge region of the sensor array 110, and thus, the fingerprint sensing module 200 may detect whether or not the fingerprint is forged based on whether or not the distance is present between the contact object and the edge region of the sensor array.

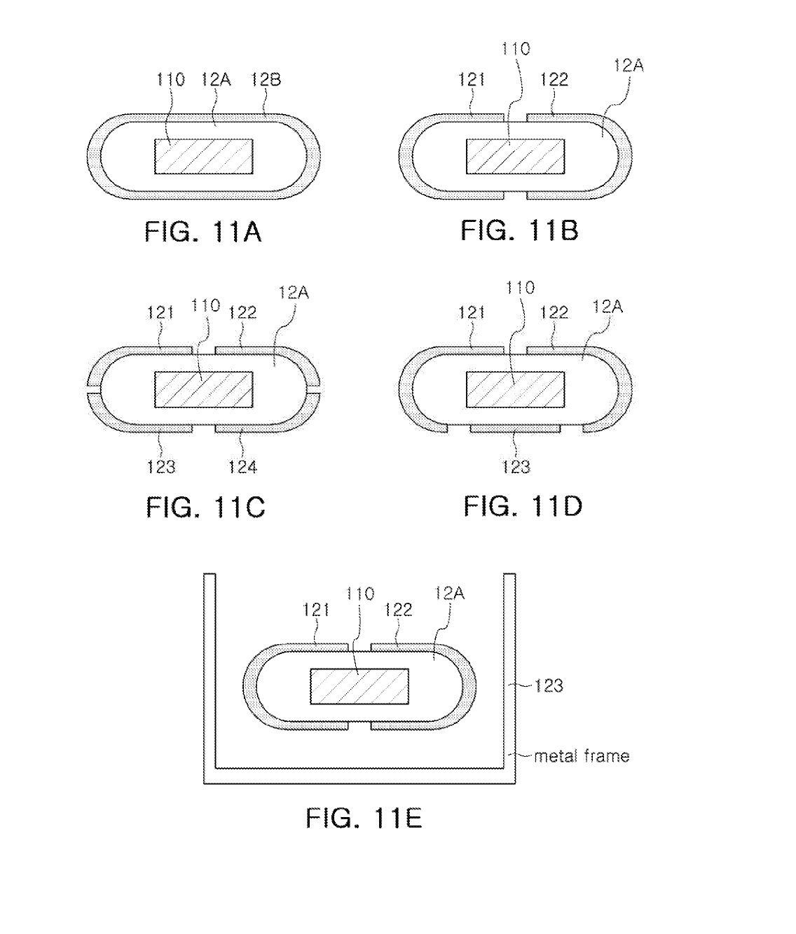

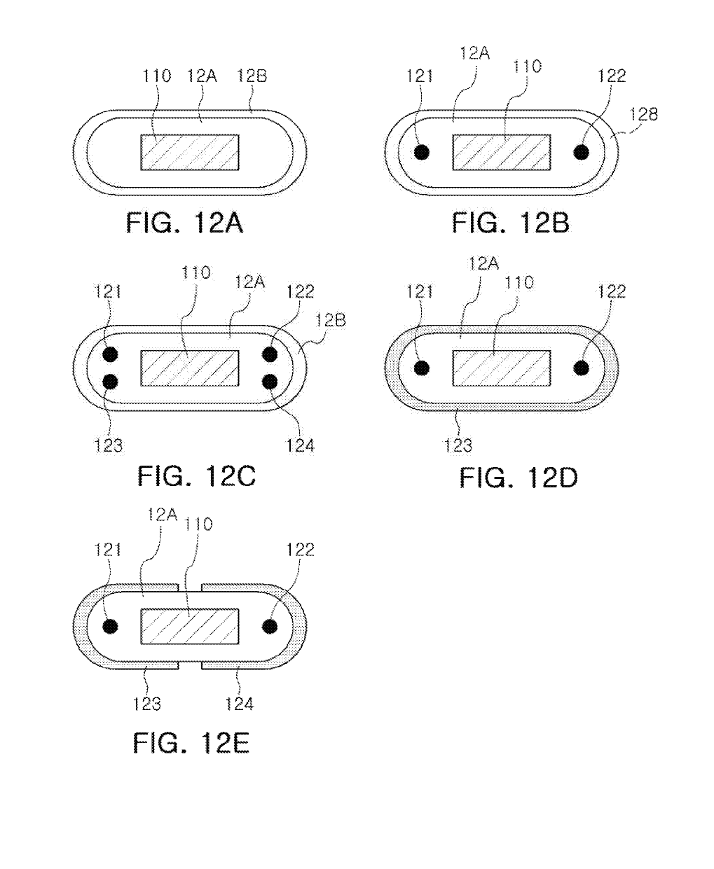

As described with reference to FIG. 1, the fingerprint sensor 10 may be formed below at least one of the region in which the display 11 is provided and the bezel region in which the first auxiliary input 12 and the second auxiliary input 13 are provided. Hereinafter, example schemes of implementing a fingerprint sensor will be described with reference to FIGS. 11A through 12E.

FIGS. 11A through 12E illustrate layouts and implementations of a touch panel.

In the example of FIG. 11A, the first auxiliary input 12 includes a home button 12A for receiving a physical input of the user and a metal ring 12B formed at an outer perimeter of the home button 12A. The sensor array 110 is positioned in a central portion of the home button 12A, and auxiliary electrodes of the auxiliary electrode unit 120 are formed by dividing the metal ring 12B into a plurality of parts.

In the example of FIG. 11B, two auxiliary electrodes 121 and 122 of the auxiliary electrode unit 120 are formed by dividing the metal ring 12B into two parts. In the example of FIG. 11C, four auxiliary electrodes 121 to 124 of the auxiliary electrode unit 120 are formed by dividing the metal ring 12B into four parts. Referring to FIG. 11, three auxiliary electrodes 121 to 123 of the auxiliary electrode unit 120 are formed by dividing the metal ring 12B into three parts.

In addition, as illustrated in FIG. 11E, two auxiliary electrodes 121 and 122 of the auxiliary electrode unit 120 are formed by dividing the metal ring 12B into two parts, and another auxiliary electrode 123 is formed using a metal frame of the electronic apparatus 1.

In the example of FIG. 12A, the first auxiliary input unit 12 includes a home button 12A for receiving a physical input of the user and the metal ring 12B formed at the outer perimeter of the home button 12A. The sensor array 110 is positioned in a central portion of the home button 12A, and auxiliary electrodes of the auxiliary electrode unit 120 are formed by dividing the metal ring 12B formed at the outer side of the home button 12A into a plurality of parts or by disposing electrodes in outer regions of the home button 12A surrounding the sensor array and disposed between the sensor array 110 and the metal ring 12B.

In the example of FIG. 12B, two auxiliary electrodes 121 and 122 of the auxiliary electrode unit 120 are disposed in the outer regions of the home button 12A. In the example of FIG. 12C, four auxiliary electrodes 121 to 124 of the auxiliary electrode unit 120 are disposed in the outer regions of the home button 12A. In the example of FIG. 12D, three auxiliary electrodes 121 to 123 of the auxiliary electrode unit 120 are formed by disposing two electrodes 121 and 122 in the outer regions of the home button 12A and configuring the metal ring 12B as another electrode. In the example of FIG. 12E, four auxiliary electrodes 121 to 124 of the auxiliary electrode unit 120 are formed by disposing two dummy electrodes 121 and 122 in dummy regions corresponding to the outer regions of the home button 12A, and dividing the metal ring 12B into two parts to form two additional electrodes.

As set forth above, according to embodiments disclosed herein, a electrodes disposed in a matrix form may be used as common electrodes to sense a fingerprint and determine a forged fingerprint, thereby increasing space efficiency and decreasing a product cost of an electronic device including a fingerprint sensor.

The fingerprint sensing circuit module 200, the driving circuit 210, the sensing circuit 220, the signal converter 230, the fingerprint analyzer 240, the forged fingerprint analyzer 300, the frequency signal provider 310, the impedance measurer 320, the fingerprint forgery determiner 330 and the host 400 in FIGS. 2 and 9 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

What is claimed is:

1. A fingerprint sensor comprising:
a panel comprising a sensor array comprising first electrodes extended in a first direction and second electrodes extended in a second direction intersecting with the first direction; and
a forged fingerprint analyzer configured to provide signals having different frequencies to a first electrode group and a second electrode group, and to measure an impedance between the first electrode group and the second electrode group to determine whether a fingerprint applied to the sensor array is forged,
wherein the first electrode group comprises a portion of a plurality of electrodes among the first electrodes or the second electrodes, and the second electrode group comprises another portion of the plurality of electrodes.

2. The fingerprint sensor of claim 1, wherein the first electrode group and the second electrode group are spaced apart from each other with an electrode among the plurality of electrodes disposed between the first electrode group and the second electrode group, and the electrode among the plurality of electrodes is floated.

3. The fingerprint sensor of claim 2, wherein some electrodes included in the first electrode group and the second electrode group are continuously disposed adjacent to each other.

4. The fingerprint sensor of claim 1, wherein the forged fingerprint analyzer comprises a frequency signal provider configured to provide a high frequency signal, a low frequency signal, and a reference signal to the first electrode group and the second electrode group.

5. The fingerprint sensor of claim 4, wherein:
the frequency signal provider is configured to provide the high frequency signal to the first electrode group, and to provide the reference signal to the second electrode group, at a first point in time; and
the frequency signal provider is configured to provide the low frequency signal to the first electrode group, and to provide the reference signal to the second electrode group, at a next point in time after the first point in time.

6. The fingerprint sensor of claim 5, wherein the forged fingerprint analyzer further comprises an impedance measurer configured to measure the impedance between the first electrode group and the second electrode group at the first point in time and the next point in time.

7. The fingerprint sensor of claim 6, wherein the forged fingerprint analyzer further comprises a forged fingerprint determiner configured to determine whether the fingerprint is forged by comparing the impedance measured at the first point in time and the impedance measured at the next point in time with each other.

8. The fingerprint sensor of claim 7, wherein the forged fingerprint analyzer is configured to determine that the fingerprint is forged, in response to a difference between the impedance measured at the first point in time and the impedance measured at the next point in time being slight.

9. The fingerprint sensor of claim 1, further comprising a fingerprint sensing circuit module configured to:
apply driving signals to the first electrodes; and
detect, from the second electrodes, capacitances generated between the first electrodes and the second electrodes to sense the fingerprint.

10. A fingerprint sensor comprising:
a panel comprising
a sensor array comprising first electrodes and second electrodes disposed above the first electrodes, and
an auxiliary electrode unit comprising auxiliary electrodes disposed adjacent to the sensor array;
a fingerprint sensing circuit module configured to sense a fingerprint from capacitances generated between the first electrodes and the second electrodes; and
a forged fingerprint analyzer configured to provide signals having different frequencies to the auxiliary electrodes, and to determine whether the fingerprint is forged based on an impedance between the auxiliary electrodes.

11. The fingerprint sensor of claim 10, wherein:
the forged fingerprint analyzer is configured to provide a high frequency signal to one or more electrodes among the auxiliary electrodes; and
the fingerprint sensing circuit module is configured to determine whether the fingerprint is forged based on capacitances formed between the second electrodes and one or more electrodes among the auxiliary electrodes.

12. The fingerprint sensor of claim 11, wherein the fingerprint sensing circuit module is further configured to determine that the fingerprint is forged, in response to an increase in the capacitances formed between the second electrodes and the one or more electrodes among the auxiliary electrodes.

13. The fingerprint sensor of claim 10, wherein the fingerprint sensing circuit module is further configured to detect whether the fingerprint is forged based on whether a distance is present between an edge region of the sensor array and a contact object disposed on the sensor array.

14. The fingerprint sensor of claim 10, wherein the panel further comprises a conductive layer formed on the auxiliary electrodes.

15. The fingerprint sensor of claim 10, wherein the sensor array is disposed in a central region of a home button configured to provide a physical input to an electronic apparatus, and the auxiliary electrodes are formed by a metal ring comprising two parts formed on an outer side of the home button.

16. The fingerprint sensor of claim 10, wherein the sensor array is disposed in a central region of a home button configured to provide a physical input to an electronic apparatus, and the auxiliary electrodes are disposed in outer regions of the home button surrounding the central region of the home button.

17. The fingerprint sensor of claim 10, wherein the panel is formed in one or both of a display region and a bezel region of an electronic apparatus.

18. The fingerprint sensor of claim 10, wherein each of the auxiliary electrodes is spaced apart from the sensor array by a distance of 3 μm or less.

19. A fingerprint sensing apparatus, comprising:
a frequency signal provider configured to provide signals having different frequencies to a sensor array comprising first electrodes extended in a first direction and second electrodes extended in a second direction;
an impedance measurer configured to measure an impedance between a first electrode group and a second electrode group, wherein the first electrode group and the second electrode group each include electrodes among the first electrodes, or each include electrodes among the second electrodes;
a fingerprint forgery determiner configured to determine whether a fingerprint applied to the sensor array is forged based on the measured impedance; and
a sensing circuit module configured to
apply driving signals to the first electrodes, and
detect, from the second electrodes, capacitances generated between the first electrodes and the second electrodes to sense the fingerprint.

20. The fingerprint sensing apparatus of claim 19, wherein:
the providing of the signals having different frequencies to the sensor array comprises
providing a first signal having a first frequency to the first electrode group, and providing a reference signal to the second electrode group, at a first point in time,
providing a second signal having a second frequency to the first electrode group, and providing the reference signal to the second electrode group, at a next point in time after the first point in time; and
the measuring of the impedance between the first electrode group and the second electrode group comprises measuring the impendence between the first electrode group and the second electrode group at the first point in time and the next point in time.

21. The fingerprint sensing apparatus of claim 20, wherein the fingerprint forgery determiner is configured to determine that the fingerprint is forged, in response to a difference between the impedance measured at the first point in time and the impedance measured at the next point in time being slight.

22. The fingerprint sensing apparatus of claim 19, wherein the first electrode group and the second electrode group are spaced apart from each other by a floated electrode.

23. An electronic apparatus comprising:
a button configured to provide a physical input to the electronic apparatus, wherein the button comprises
a sensor array disposed in a central region of the button, and comprising first electrodes and second electrodes, and
auxiliary electrodes disposed in the button in one or both of an outer region of the button surrounding the sensor array and a metal ring formed at an outer circumference of the button; a fingerprint sensing circuit module configured to sense a fingerprint from capacitances generated between the first electrodes and the second electrodes by a contact object disposed on the sensor array; and
a forged fingerprint analyzer configured to determine whether the fingerprint is forged based on capacitances formed between the second electrodes and an electrode among the auxiliary electrodes.

24. The electronic apparatus of claim 23, wherein each of the auxiliary electrodes is spaced apart from the sensor array by a distance less than 3 μm.

25. The electronic apparatus of claim 23, wherein the forged fingerprint analyzer is further configured to:
provide signals having different frequencies to the auxiliary electrodes; and
determine whether the fingerprint is forged based on an impedance between the auxiliary electrodes.

26. The electronic apparatus of claim 23, wherein the fingerprint sensing circuit module is further configured to detect whether the fingerprint is forged based on whether a distance is present between an edge region of the sensor array and the contact object.
